(19) United States
(12) Patent Application Publication
(10) Pub. No.: US 2021/0355245 A1
(43) Pub. Date: Nov. 18, 2021

(54) PREPARATION METHOD FOR GRANULAR OCTENYL SUCCINIC ANHYDRIDE STARCH ESTER

(71) Applicants: Ningxia Academy of Agriculture and Forestry Sciences, Yinchuan (CN); Wolfberry Scientific Institute, Ningxia Academy of Agriculture and Forestry Sciences, Yinchuan (CN); Tianjin University of Science & Technology, Binhai New District (CN)

(72) Inventors: Jinwei WANG, Binhai New District (CN); Shujun WANG, Binhai New District (CN); Fei REN, Binhai New District (CN)

(21) Appl. No.: 17/389,330

(22) Filed: Jul. 29, 2021

Related U.S. Application Data
(63) Continuation of application No. PCT/CN2020/084592, filed on Apr. 10, 2020.

(30) Foreign Application Priority Data
Apr. 3, 2020 (CN) CN2020102581334

(51) Int. Cl. C08B 31/04

(52) U.S. Cl. CPC C08B 31/04; B29B 9/02

(57) ABSTRACT

An efficient preparation method for a novel octenyl succinic anhydride granular starch ester is provided. The preparation method includes: taking an ionic liquid composite solution as a medium and generating an octenyl succinic anhydride granular starch ester through an esterification reaction between starch and octenyl succinic anhydride, wherein the ionic liquid is a 1-ethyl-3-methylimidazolium acetate ionic liquid. The preparation method for an octenyl succinic anhydride starch ester firstly applies an ionic liquid aqueous solution system to preparation of an octenyl succinic anhydride granular starch ester of different types of starch, the synthesis efficiency of the octenyl succinic anhydride starch ester is effectively improved, a granular structure of a final product is remained, and functional properties of the final product are improved.

### CROSS REFERENCE TO RELATED APPLICATION

This application is a PCT application entering US phase with international application No. PCT/CN 2020/084592 filed on Apr. 10, 2020 and entitled “preparation method for a novel octenyl succinic anhydride granular starch ester” claiming the priority of a Chinese patent application with application No. CN2020102581334 filed on Apr. 3, 2020 and entitled “preparation method for a novel octenyl succinic anhydride granular starch ester”.

### TECHNICAL FIELD

The present invention relates to the field of chemical modification of starch, and particularly relates to a preparation method for a novel octenyl succinic anhydride granular starch ester in an ionic liquid aqueous solution system.

### BACKGROUND

In recent years, due to the reduction of fossil fuel resources, the efficient utilization trend of biomass of various industrial products has become increasingly apparent. Starch is an easily available, renewable, nontoxic and biodegradable native polysaccharide molecule. As one of the most abundant polysaccharides in nature, the starch has been used as a multi-purpose ecologically compatible biopolymer material, but the application of the starch to various industries is limited by limitation of native starch in aspects of functional properties. Therefore, the purpose of modifying the starch is to overcome defects of native starch so that it can be better applied to industrial production.

Starch modification measures generally include physical, chemical and biological modification methods. The chemical modification method is a relatively mature starch treatment method at present, and has the advantages of great starch treatment capacity and easy realization of industrialized mass production. For most chemical modification on starch, new functional groups are introduced into (between) starch molecules through derivatization, such as esterification, etherification or cross-linking reactions, thus causing great changes in the functional properties of starch.

Octenyl succinic anhydride (OSA) having a molecular formula of C₁₂H₁₈O₃ and a molecular weight of 210.27, has a unique cyclic dicarboxylic acid structure, and enables the original hydrophilic starch to gain a hydrophobic characteristic due to the introduction of succinic acid groups when taking an esterification reaction with the starch, thus causing amphipathicity of the whole molecule. Amphiphilic polymers are widely applied to the fields of emulsification, packaging, film coating and gel production, and an octenyl succinic anhydride starch ester has an excellent emulsification characteristic, and can be widely used as an emulsifier or embedding material and the like in food, medicine and cosmetic industries.

The OSA-starch is generally synthesized under water phase conditions, and its essence is to take an esterification reaction between the OSA and starch granules under alkaline conditions. Since the solubility of the OSA in water is very low and the surface structures of different types of starch granules are different, it is difficult for the OSA to sufficiently contact with and penetrate into the starch granules when the modification reaction occurs, thereby resulting in low reaction efficiency. Therefore, it is important to influence the reaction activity of the starch and the OSA by changing an esterification reaction medium, and the reaction efficiency will be directly influenced.

In the past few decades, room temperature ionic liquids (also referred as ionic liquids, ILs) have become ideal green solvents and esterification reaction media for carbohydrates (cellulose and starch) due to their advantages of biodegradability, low toxicity, recyclability and the like. Compared with a traditional reaction medium, the ILs have the advantages that the starch esterification reaction efficiency and the substitution degree in an ionic liquid system are obviously improved, but the modification reaction conditions in a pure ionic liquid system are often severe (high temperature, long time or catalyst addition), so that starch granule structures are damaged, the functional properties of the starch are lost, and at the same time, more side reactions are generated.

### SUMMARY

The present invention provides an efficient preparation method for a novel octenyl succinic anhydride granular starch ester.

The present invention adopts the following technical solution:

An octenyl succinic anhydride granular starch ester is prepared from corn starch or potato starch through an esterification reaction with octenyl succinic anhydride in a 1-ethyl-3-methylimidazoliumacetate ionic liquid composite solution.

The octenyl succinic anhydride granular starch ester is prepared from the following steps:

1) preparing ionic liquid aqueous solution systems at a room temperature for modifying octenyl succinic anhydride of the granular starch ester, wherein the room temperature in the present invention is 20 to 25° C.; and
2) preparing the octenyl succinic anhydride granular starch ester by adopting a wet process and taking an esterification reaction between starch from different plants and the octenyl succinic anhydride in the ionic liquid aqueous solution systems.

An embodiment of the present invention provides a preparation method for an octenyl succinic anhydride starch ester, including the following steps:

1) preparing an ionic liquid composite solution under conditions of room temperature and stirring, wherein the ionic liquid composite solution is a mixed solution of a 1-ethyl-3-methylimidazolium acetate ionic liquid and deionized water; and
2) preparing starch emulsion from starch and the ionic liquid composite solution obtained from step 1); then, adding a sodium hydroxide solution into the starch emulsion to adjust a pH value of a mixture to 8.5; at a room temperature, adding octenyl succinic anhydride into the starch emulsion to take an esterification reaction, maintaining a pH value of a reaction system at 8.4 to 8.5, and continuously performing stirring; after the reaction is completed, adjusting a pH value of a reacted emulsion to 6.5 by a hydrochloric acid solution; then, performing centrifugation, washing and drying to obtain an octenyl succinic anhydride starch ester, wherein the obtained starch ester is granular starch ester.

In the step 1), a temperature for preparing the ionic liquid composite solution is 23° C., and a stirring rate is 300 rpm.

Other plant starch such as mung bean starch, sweet potato starch and rice starch also can be modified by the above method and reaction system of the present invention.

Most octenyl succinic anhydride modified starch with a high substitution degree is obtained in an organic solvent with defect of starch granule structure damage. By such a method, although the substitution degree is very high, partial functional properties of the starch may be lost due to its granule structure damage. However, the octenyl succinic anhydride granular starch ester prepared by the method of the present invention, under the same conditions compared to conventional methods, the substitution degree is improved, and at the same time, various functional properties of the starch itself such as granular structure are remained.

Compared with conventional methods, the method of the present invention has the following advantages and effects:

(1) The present invention is applicable to octenyl succinic anhydride esterification modification of starch from different plants, is simple in operation and easy to implement, achieves energy-saving, low-consumption, green and sustainable effects, is easy for industrial production, and provides a new idea for preparation of the novel octenyl succinic anhydride starch ester.
(2) The present invention uses a principle that a mixed solution of 1-ethyl-3-methylimidazoliumacetate and deionized water as a reaction medium has a weak damage effect on the starch granule structures, firstly uses the mixed solution as a modification medium to be applied to a modification preparation method for the octenyl succinic anhydride starch ester, remains the granule form of the starch and partial functional properties of the starch, and also gives novel properties to the starch, so that better emulsification performance, including emulsification activity or emulsification stability is realized, the synthesis efficiency of the octenyl succinic anhydride granular starch ester is effectively improved, and the functional properties of a final product are greatly improved so as to meet requirements of different industrial products.

### BRIEF DESCRIPTION OF THE DRAWINGS

FIG. 1 shows an electron scanning microscope granular microstructure of an octenyl succinic anhydride starch ester according to Embodiment 8.

FIG. 2 shows an electron scanning microscope microstructure of a starch ester according to Comparative example 1.

FIG. 3 shows an electron scanning microscope microstructure of a starch ester according to Comparative example 2.

FIG. 4 shows an electron scanning microscope microstructure of a starch ester according to Comparative example 3.

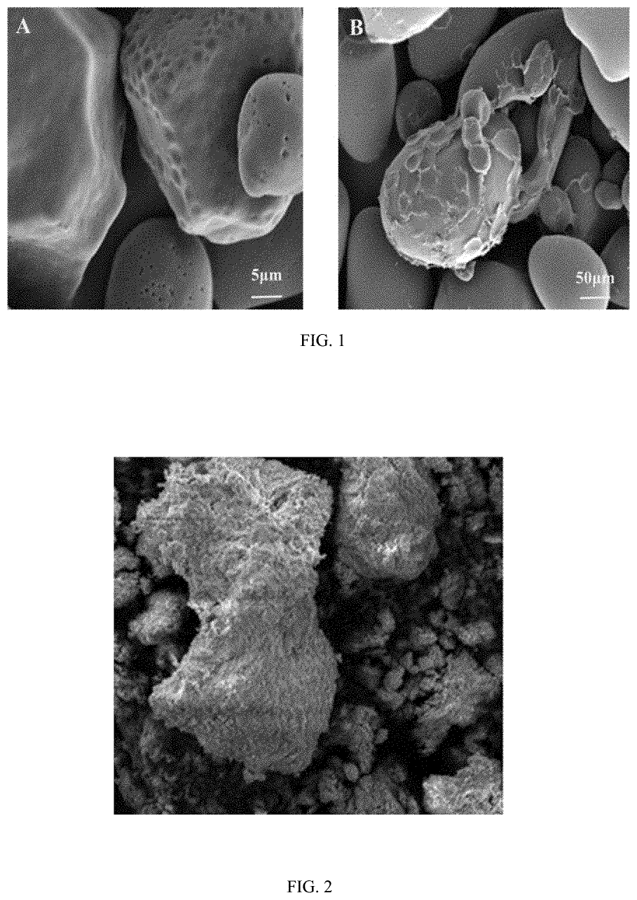

### DETAILED DESCRIPTION OF THE EMBODIMENTS

Illustrative implementations of the disclosure will be further described in detail hereafter for further illustrating the present invention. Although exemplary implementations of the disclosure are shown in the specification, it should be understood that the disclosure may be realized in various forms and should not be limited to the implementations set forth herein. Oppositely, these implementations are provided so that this disclosure will be more thoroughly understood, and the scope of the disclosure will be completely told to those skilled in the art, so as to provide those skilled in the art with a more complete, accurate and thorough understanding of the inventive concepts and technical solutions of the present invention.

### Embodiment 1

1) Ionic liquid aqueous solution systems with different mass ratios were prepared at a room temperature (20 to 25° C.) for modifying octenyl succinic anhydride of a granular starch ester.
2) An octenyl succinic anhydride granular starch ester was prepared by adopting a wet process and taking an esterification reaction between starch from different plants and the octenyl succinic anhydride in the ionic liquid aqueous solution system.

### Embodiment 2

Corn starch or potato starch was respectively used as raw material examples to prepare an octenyl succinic anhydride granular starch ester specifically according to the following steps:

1) Preparation of an ionic liquid composite solution: a certain mass of deionized water was added into a certain amount of 1-ethyl-3-methylimidazolium acetate ionic liquid to be prepared into a mixed solution of 2:8 (w/w), and magnetic stirring (300 rpm) was performed at a room temperature for 3 min to obtain the ionic liquid composite solution.
2) Starch emulsion was prepared from corn starch or potato starch with the prepared ionic liquid composite solution. Then, a sodium hydroxide solution was added to adjust a pH value of the starch emulsion to 8.5, at a certain temperature, octenyl succinic anhydride was added into the starch emulsion to take an esterification reaction, a pH value of a reaction system was maintained at 8.4 to 8.5, and stirring was continuously performed. After the reaction was completed, a pH value of a reacted emulsion was adjusted to 6.5 by a hydrochloric acid solution. Then, centrifugation and washing were alternately performed with deionized water and 70% ethanol, and next drying was performed to obtain an octenyl succinic anhydride granular starch ester.

### Embodiment 3

Corn starch or potato starch was respectively used as raw material examples to prepare an octenyl succinic anhydride granular starch ester specifically according to the following steps:

1) Preparation of an ionic liquid composite solution: a certain mass of deionized water was added into a certain amount of 1-ethyl-3-methylimidazolium acetate ionic liquid to be prepared into a mixed solution of 5:5 (w/w), and magnetic stirring (300 rpm) was performed at a room temperature for 3 min to obtain an ionic liquid aqueous solution, i.e. the ionic liquid composite solution.
2) Starch emulsion was prepared from corn starch or potato starch with the prepared ionic liquid composite solution. Then, a sodium hydroxide solution was added to adjust a pH value of the starch emulsion to 8.5, at a certain temperature, octenyl succinic anhydride was added into the starch emulsion to take an esterification reaction, a pH value of a reaction system was maintained at 8.4 to 8.5, and stirring was continuously performed. After the reaction was completed, a pH value of a reacted emulsion was adjusted to 6.5 by a hydrochloric acid solution. Then, centrifugation and washing were alternately performed with deionized water and 70% ethanol, and next drying was performed to obtain an octenyl succinic anhydride granular starch ester.

### Embodiment 4

Corn starch or potato starch was respectively used as raw material examples to prepare an octenyl succinic anhydride granular starch ester specifically according to the following steps:

1) Preparation of an ionic liquid composite solution: a certain mass of deionized water was added into a certain amount of 1-ethyl-3-methylimidazolium acetate ionic liquid to be prepared into a mixed solution of 8:2 (w/w), and magnetic stirring (300 rpm) was performed at a room temperature for 3 min to obtain the ionic liquid composite solution.
2) Starch emulsion was prepared from corn starch and potato starch with the prepared ionic liquid composite solution. Then, a sodium hydroxide solution was added to adjust a pH value of the starch emulsion to 8.5, at a certain temperature, octenyl succinic anhydride was added into the starch emulsion to take an esterification reaction, a pH value of a reaction system was maintained at 8.4 to 8.5, and stirring was continuously performed. After the reaction was completed, a pH value of a reacted emulsion was adjusted to 6.5 by a hydrochloric acid solution. Then, centrifugation and washing were alternately performed with deionized water and 70% ethanol, and next drying was performed to obtain an octenyl succinic anhydride granular starch ester.

### Embodiment 5

Corn starch or potato starch was respectively used as raw material examples to prepare an octenyl succinic anhydride granular starch ester specifically according to the following steps:

1) Preparation of an ionic liquid composite solution: a certain mass of deionized water was added into a certain amount of 1-ethyl-3-methylimidazolium acetate ionic liquid to be prepared into a mixed solution of 2:8 (w/w), and magnetic stirring (300 rpm) was performed at 23° C. for 3 min to obtain the ionic liquid composite solution.
2) Synthesis of octenyl succinic anhydride granular starch esters: 15 wt % starch emulsion was respectively prepared from corn starch and potato starch with the prepared ionic liquid composite solution. Then, a 3% NaOH solution was added to adjust a pH value of the starch emulsion to 8.5, and octenyl succinic anhydride of 3% on a dry starch weight basis was weighed, was diluted for 5 times with isopropanol, and was dropwise added into the starch emulsion within 2 hours. A pH value of the whole reaction system was maintained at 8.4 to 8.5 under the magnetic stirring at 35° C. A rotating speed of the magnetic stirring was 200 rpm, and the reaction was continuously performed for 4 h. Then, a pH value of the reacted starch emulsion was adjusted to 6.5 by a 3% HCl solution. The obtained starch emulsion was firstly subjected to centrifugation and washing once with 70% ethanol, and then subjected to centrifugation and washing once with deionized water, and the operation was repeated for 3 times at centrifugation force of 4500 g for centrifugation time of 10 min to obtain a starch ester sample. The starch ester sample was placed in a baking oven of 30° C. to be dried for 12 h, then, grinding was performed, sieving was performed by a 100-mesh sieve screen, and an octenyl succinic anhydride corn starch ester A1 and an octenyl succinic anhydride potato starch ester A2 were obtained.

### Embodiment 6

Corn starch or potato starch was respectively used as raw material examples to prepare an octenyl succinic anhydride granular starch ester specifically according to the following steps:

1) Preparation of an ionic liquid composite solution: a certain mass of deionized water was added into a certain amount of 1-ethyl-3-methylimidazoliumacetate ionic liquid to be prepared into a mixed solution of 5:5 (w/w), and magnetic stirring (300 rpm) was performed at 23° C. for 3 min to obtain the ionic liquid composite solution.
2) Synthesis of octenyl succinic anhydride starch esters: 15 wt % starch emulsion was prepared from corn starch or potato starch with the prepared ionic liquid composite solution. Then, a 3% NaOH solution was added to adjust a pH value of the starch emulsion to 8.5, and octenyl succinic anhydride of 3% on a dry starch weight basis was weighed, was diluted for 6 times with isopropanol, and was dropwise added into the starch emulsion within 2 hours. A pH value of the whole reaction system was maintained at 8.4 to 8.5 under the magnetic stirring at 20° C. A rotating speed of the magnetic stirring was 200 rpm, and the reaction was continuously performed for 5 h. Then, a pH value of the reacted starch emulsion was adjusted to 6.5 by a 3% HCl solution. The obtained starch emulsion was firstly subjected to centrifugation and washing once with 70% ethanol, and then subjected to centrifugation and washing once with deionized water, and the operation was repeated for 3 times at centrifugation force of 4500 g for centrifugation time of 10 min to obtain a starch ester sample. The starch ester sample was placed in a baking oven of 30° C. to be dried for 12 h, then, grinding was performed, sieving was performed by a 100-mesh sieve screen, and an octenyl succinic anhydride corn starch ester B1 and an octenyl succinic anhydride potato starch ester B2 were obtained.

### Embodiment 7

Corn starch or potato starch was respectively used as raw material examples to prepare an octenyl succinic anhydride granular starch ester specifically according to the following steps:

1) Preparation of an ionic liquid composite solution: a certain mass of deionized water was added into a certain amount of 1-ethyl-3-methylimidazoliumacetate ionic liquid to be prepared into a mixed solution of 8:2 (w/w), and magnetic stirring (300 rpm) was performed at 23° C. for 3 min to obtain the ionic liquid composite solution.
2) Synthesis of octenyl succinic anhydride starch esters: 15 wt % starch emulsion was prepared from corn starch or potato starch with the prepared ionic liquid composite solution. Then, a 3% NaOH solution was added to adjust a pH value of the starch emulsion to 8.5, and octenyl succinic anhydride of 3% on a dry starch weight basis was weighed, was diluted for 3 times with isopropanol, and was dropwise added into the starch emulsion within 2 hours. A pH value of the whole reaction system was maintained at 8.4 to 8.5 under the magnetic stirring at 40° C. A rotating speed of the magnetic stirring was 200 rpm, and the reaction was continuously performed for 3 h. Then, a pH value of the reacted starch emulsion was adjusted to 6.5 by a 3% HCl solution. The obtained starch emulsion was firstly subjected to centrifugation and washing once with 70% ethanol, and then subjected to centrifugation and washing once with deionized water, and the operation was repeated for 3 times at centrifugation force of 4500 g for centrifugation time of 10 min to obtain a starch ester sample. The starch ester sample was placed in a baking oven of 30° C. to be dried for 12 h, then, grinding was performed, sieving was performed by a 100-mesh sieve screen, and an octenyl succinic anhydride corn starch ester C1 and an octenyl succinic anhydride potato starch ester C2 were obtained.

### Experimental Example 1

The octenyl succinic anhydride corn starch esters A1-C1 and octenyl succinic anhydride potato starch esters A2-C2 according to Embodiments 5-7 were compared to a traditional octenyl succinic anhydride corn/potato starch ester subjected to modification treatment in a water phase medium in two aspects of substitution degree and emulsification capability (emulsification activity and emulsification stability). At the same time, the octenyl succinic anhydride corn starch esters A1-C1 and octenyl succinic anhydride potato starch esters A2-C2 according to Embodiments 5-7 were compared to the traditional octenyl succinic anhydride corn/potato starch ester subjected to modification treatment in the water phase medium in an aspect of synthesis efficiency. Except for the reaction system, other steps of the traditional preparation methods were enabled to be identical to the steps of the preparation method of Embodiment 5. The comparison results were as shown in Table 1:

TABLE 1
Comparison of octenyl succinic anhydride starch esters prepared
from different reaction media in aspects of substitution degree,
reaction efficiency and emulsification capability

| | | Reaction | | Emulsification |
|---|---|---|---|---|
| | Substitution | efficiency | Emulsification | stability |
| Embodiment | degree | (%) | activity | (min) |
| Octenyl succinic | 0.0153 ± 0.0001b | 65.7 ± 0.0b | 1.23 ± 0.00c | 338.17 ± 7.16c |
| anhydride corn | | | | |
| starch ester | | | | |
| prepared in | | | | |
| water phase | | | | |
| Octenyl succinic | 0.0207 ± 0.0001a | 89.1 ± 0.6a | 1.37 ± 0.01d | 582.55 ± 3.64d |
| anhydride | | | | |
| corn starch ester | | | | |
| A1 | | | | |
| Octenyl succinic | 0.0157 ± 0.0004b | 67.4 ± 1.4b | 1.23 ± 0.01c | 325.23 ± 14.37c |
| anhydride | | | | |
| corn starch ester | | | | |
| B1 | | | | |
| Octenyl succinic | 0.0095 ± 0.0003c | 40.9 ± 1.1c | 0.93 ± 0.00b | 209.26 ± 2.29b |
| anhydride | | | | |
| corn starch ester | | | | |
| C1 | | | | |
| Octenyl succinic | 0.0122 ± 0.0001b | 52.2 ± 0.4b | 0.93 ± 0.01d | 297.34 ± 1.94d |
| anhydride | | | | |
| potato starch | | | | |
| ester prepared in | | | | |
| water phase | | | | |
| Octenyl succinic | 0.0137 ± 0.0003a | 59.0 ± 1.3a | 1.16 ± 0.01e | 383.19 ± 9.79e |
| anhydride | | | | |
| potato starch | | | | |
| ester A2 | | | | |
| Octenyl succinic | 0.0113 ± 0.0002c | 48.6 ± 0.8c | 0.88 ± 0.01c | 250.72 ± 3.39c |
| anhydride | | | | |
| potato starch | | | | |
| ester B2 | | | | |
| Octenyl succinic | 0.0088 ± 0.0000d | 38.0 ± 0.2d | 0.46 ± 0.02b | 194.20 ± 3.62b |
| anhydride | | | | |
| potato starch | | | | |
| ester C2 | | | | |

Note:
each value is mean ± standard deviation. There was no statistical significance for differences of the values with same letters in the same column (p < 0.05).

From Table 1, it could be known that the substitution degrees of the octenyl succinic anhydride granular starch esters A1 and A2 prepared in the 1-ethyl-3-methylimidazoliumacetate ionic liquid aqueous solution were higher than that of the conventional octenyl succinic anhydride starch ester prepared in the water phase, the improvement effects of the reaction efficiency and substitution degree were obvious, and the emulsification activity and the emulsification stability were also greatly improved. It showed that by using a novel system of an “ionic liquid aqueous solution” as a reaction medium, an obvious promotion effect was achieved on the subsequent octenyl succinic anhydride modification. Each index of the octenyl succinic anhydride corn starch ester A1 was obviously superior to that of the octenyl succinic anhydride potato starch ester A2, and it showed that the corner starch achieved a better effect when being applied to the technical solution of the present invention.

### Embodiment 8

Mung bean starch, sweet potato starch or rice starch was respectively used as raw material examples to prepare an octenyl succinic anhydride granular starch ester specifically according to the following steps:

1) Preparation of an ionic liquid composite solution: a certain mass of deionized water was added into a certain amount of 1-ethyl-3-methylimidazoliumacetate ionic liquid to be prepared into a mixed solution of 2:8 (w/w), and magnetic stirring (300 rpm) was performed at 23° C. for 3 min to obtain the ionic liquid composite solution.
2) Synthesis of octenyl succinic anhydride granular starch esters: 15 wt % starch emulsion was respectively prepared from mung bean starch, sweet potato starch or rice starch with the prepared ionic liquid composite solution. Then, a 3% NaOH solution was added to adjust a pH value of the starch emulsion to 8.5, and octenyl succinic anhydride of 3% on a dry starch weight basis was weighed, was diluted for 5 times with isopropanol, and was dropwise added into the starch emulsion within 2 hours. A pH value of the whole reaction system was maintained at 8.4 to 8.5 under the magnetic stirring at 35° C. A rotating speed of the magnetic stirring was 200 rpm, and the reaction was continuously performed for 4 h. Then, a pH value of the reacted starch emulsion was adjusted to 6.5 by a 3% HCl solution. The obtained starch emulsion was firstly subjected to centrifugation and washing once with 70% ethanol, and then subjected to centrifugation and washing once with deionized water, and the operation was repeated for 3 times at centrifugation force of 4500 g for centrifugation time of 10 min to obtain a starch ester sample. The starch ester sample was placed in a baking oven of 30° C. to be dried for 12 h, then, grinding was performed, sieving was performed by a 100-mesh sieve screen, and an octenyl succinic anhydride mung bean starch ester A3, an octenyl succinic anhydride sweet potato starch ester A4 and an octenyl succinic anhydride and rice starch ester A5 were obtained.

Through detection, each index of the A3, A4 and A5 was similar to that of the A1 and A2, but was a little worse than that of the A1 and A2.

### Comparative Example 1

Potato starch was used as a raw material example to prepare an octenyl succinic anhydride granular starch ester specifically according to the following steps:

1) Preparation of “pure ionic liquid system”: a 1-ethyl-3-methylimidazolium acetate ionic liquid was magnetically stirred for 1 h at 90° C. to obtain the pure ionic liquid system.
2) Synthesis of starch ester: 10 wt % starch emulsion was prepared from potato starch with the pure ionic liquid system in step 1), and other operations were the same as those in Embodiment 8.

An electron scanning microscope microstructure of the obtained starch ester was as shown in FIG. 2.

### Comparative Example 2

Potato starch was used as a raw material example to prepare an octenyl succinic anhydride granular starch ester specifically according to the following steps:

1) Preparation of an ionic liquid composite solution: a 1-butyl-3-methylimidazolium chloride ionic liquid and water were mixed and magnetically stirred for 2 h at 100° C.
2) Synthesis of starch ester: 10 wt % starch emulsion was prepared from corn starch with the ionic liquid composite liquid prepared in step 1), and other operations were the same as those in Embodiment 8.

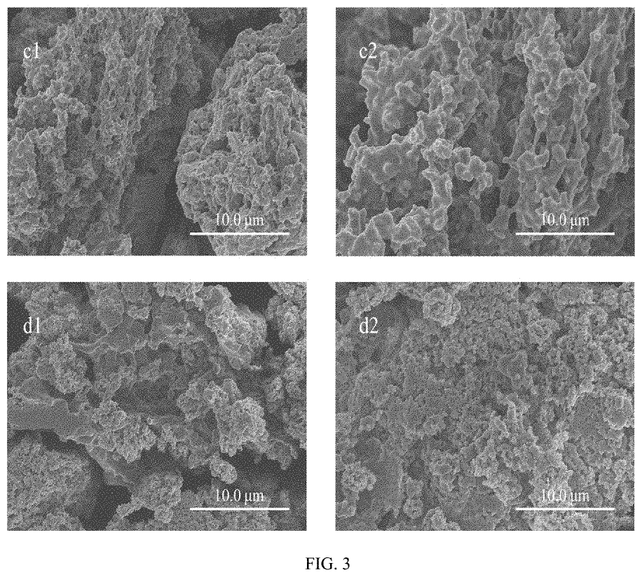

An electron scanning microscope microstructure of the obtained starch ester was as shown in FIG. 3.

### Comparative Example 3

1) Preparation of an ionic liquid composite solution: a 1-butyl-3-methylimidazolium tetrafluoroborate ionic liquid and water were mixed and magnetically stirred for 11 h at 80° C.
2) Synthesis of starch ester: 10 wt % starch emulsion was prepared from corn starch with the ionic liquid composite liquid prepared in step 1), and other operations were the same as those in Embodiment 8.

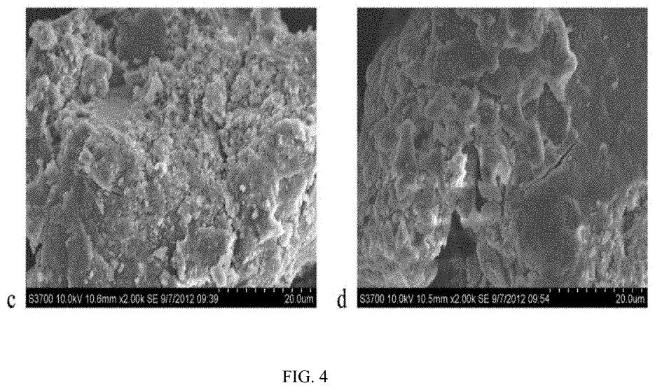

An electron scanning microscope microstructure of the starch ester was as shown in FIG. 4.

The method of the present application provides an octenyl succinic anhydride granular starch ester, the granule structure of the starch ester is remained, and the functional properties of the starch, such as swelling force, paste viscosity and gel performance are further remained. Usually, the substitution degree is difficult to improve, and the emulsification performance is low without damaging the granular structure. From Table 1 and Table 2, for the modified starch by the method of the present application, the substitution degree of the starch ester was further improved under the condition of remaining the granule structure, and the better emulsification performance was achieved when the granule state was maintained.

The preparation method of the embodiments of the present invention was performed at a room temperature of 20 to 25° C. without adding any catalyst, the reaction conditions were mild, the cost was low, the process was simple, and the industrial application was easy.

The contents mentioned above are only exemplary implementations of the present invention, but do not limit the protection scope of the present invention, and anyone skilled in the art may easily think of mortifications or alternations within the technical scope disclosed by the present invention, and all of these mortifications or alternations should be contained within the protection scope of the present invention. Therefore, the protection scope of the present invention shall be defined by the protection scope of claims appended hereto.

What is claimed is:

1. A preparation method for an octenyl succinic anhydride starch ester, comprising the following steps:
1) preparing an ionic liquid composite solution under conditions of room temperature and stirring, wherein the ionic liquid composite solution is a mixed liquid of a 1-ethyl-3-methylimidazoliumacetate ionic liquid and deionized water; and
2) preparing starch emulsion from starch and the ionic liquid composite solution; then, adding a sodium hydroxide solution to adjust a pH value of the starch emulsion to 8.5; at a room temperature, adding octenyl succinic anhydride into the starch emulsion to take an esterification reaction, maintaining a pH value of a reaction system at 8.4 to 8.5, and continuously performing stirring; after the reaction is completed, adjusting a pH value of a reacted emulsion to 6.5 by a hydrochloric acid solution; then, performing centrifugation and washing, and next performing drying to obtain the octenyl succinic anhydride starch ester, wherein the obtained starch ester is granular starch ester.

2. The preparation method for an octenyl succinic anhydride starch ester according to claim 1, wherein the centrifugation and washing are alternately performed with deionized water and 70% ethanol.

3. The preparation method for an octenyl succinic anhydride starch ester according to claim 1, wherein a mass ratio of the 1-ethyl-3-methylimidazoliumacetate ionic liquid to deionized water in the ionic liquid composite solution is 2:8 to 8:2.

4. The preparation method for an octenyl succinic anhydride starch ester according to claim 1, wherein a mass ratio of the 1-ethyl-3-methylimidazoliumacetate ionic liquid to deionized water in the ionic liquid composite solution is 2:8, 5:5 or 8:2.

5. The preparation method for an octenyl succinic anhydride starch ester according to claim 1, wherein a mass ratio of the 1-ethyl-3-methylimidazoliumacetate ionic liquid to deionized water in the ionic liquid composite solution is 2:8.

6. The preparation method for an octenyl succinic anhydride starch ester according to claim 1, wherein in the step 1), a temperature for preparing the ionic liquid composite solution is 23° C., and a stirring speed is 300 rpm.

7. The preparation method for an octenyl succinic anhydride starch ester according to claim 1, wherein in the step 2), preparing starch emulsion from starch with the prepared ionic liquid composite solution; then, adding a sodium hydroxide solution to adjust a pH value of the starch emulsion to 8.5; at a room temperature, adding octenyl succinic anhydride into the starch emulsion to take an esterification reaction, maintaining a pH value of a reaction system at 8.4 to 8.5, and continuously performing stirring; after the reaction is completed, adjusting a pH value of a reacted emulsion to 6.5 by a hydrochloric acid solution; and then, performing centrifugation and washing alternately with deionized water and 70% ethanol, and next performing drying to obtain octenyl succinic anhydride granular starch ester.

8. The preparation method for an octenyl succinic anhydride starch ester according to claim 6, wherein in the step 2), preparing starch emulsion with a concentration of 15 wt % from starch with the prepared ionic liquid composite solution; then, adding a sodium hydroxide solution with a concentration of 3% to adjust a pH value of the starch emulsion to 8.5; firstly weighing octenyl succinic anhydride of 3% on a dry starch weight basis, diluting the octenyl succinic anhydride for 3 to 6 times with isopropanol, and at a temperature of 20 to 40° C., dropwise adding the diluted octenyl succinic anhydride into the starch emulsion within 2 hours to take an esterification reaction; performing magnetic stirring during the esterification reaction at a rotating speed of 200 rpm; controlling the whole reaction time to be 3 to 5 hours; after the reaction is completed, adjusting a pH value of a reacted emulsion to 6.5 by a hydrochloric acid solution with a concentration of 3%; performing centrifugation and washing alternately with deionized water and 70% ethanol for three times at centrifugation force of 4500 g for centrifugation time of 10 minutes; and performing drying in mode of being placed in a baking oven of 30° C. for 12 hours to obtain an octenyl succinic anhydride granular starch ester.

9. The preparation method for an octenyl succinic anhydride starch ester according to claim 8, wherein the starch is corn starch, potato starch, mung bean starch, sweet potato starch and rice starch.

10. The preparation method for an octenyl succinic anhydride starch ester according to claim 1, wherein in the step 2), preparing starch emulsion with a concentration of 15 wt % from starch with the prepared ionic liquid composite solution; then, adding a sodium hydroxide solution with a concentration of 3% to adjust a pH value of the starch emulsion to 8.5; firstly weighing octenyl succinic anhydride of 3% on a dry starch weight basis, diluting the octenyl succinic anhydride for 3 to 6 times with isopropanol, and at a temperature of 20 to 40° C., dropwise adding the diluted octenyl succinic anhydride into the starch emulsion within 2 hours to take an esterification reaction; performing magnetic stirring during the esterification reaction at a rotating speed of 200 rpm; controlling the whole reaction time to be 3 to 5 hours; after the reaction is completed, adjusting a pH value of a reacted emulsion to 6.5 by a hydrochloric acid solution with a concentration of 3%; performing centrifugation and washing alternately with deionized water and 70% ethanol for three times at centrifugation force of 4500 g for centrifugation time of 10 minutes; and performing drying in mode of being placed in a baking oven of 30° C. for 12 hours to obtain the octenyl succinic anhydride granular starch ester.

11. The preparation method for an octenyl succinic anhydride starch ester according to claim 5, wherein in the step 2), preparing starch emulsion with a concentration of 15 wt % from starch with the prepared ionic liquid composite solution; then, adding a sodium hydroxide solution with a concentration of 3% to adjust a pH value of the starch emulsion to 8.5; firstly weighing octenyl succinic anhydride of 3% on a dry starch weight basis, diluting the octenyl succinic anhydride for 3 to 6 times with isopropanol, and at a temperature of 20 to 40° C., dropwise adding the diluted octenyl succinic anhydride into the starch emulsion within 2 hours to take an esterification reaction; performing magnetic stirring during the esterification reaction at a rotating speed of 200 rpm; controlling the whole reaction time to be 3 to 5 hours; after the reaction is completed, adjusting a pH value of a reacted emulsion to 6.5 by a hydrochloric acid solution with a concentration of 3%; performing centrifugation and washing alternately with deionized water and 70% ethanol for three times at centrifugation force of 4500 g for centrifugation time of 10 minutes; and performing drying in mode of being placed in a baking oven of 30° C. for 12 hours to obtain the octenyl succinic anhydride granular starch ester.

12. An octenyl succinic anhydride granular starch ester prepared from the preparation method according to claim 1.
